(19) United States
(12) Patent Application Publication
(10) Pub. No.: US 2026/0058385 A1
(43) Pub. Date: Feb. 26, 2026

(54) CONNECTOR AND CONNECTOR PAIR

(71) Applicant: Molex, LLC, Lisle, IL (US)

(72) Inventor: Yasushi Sugizuru, Yamato (JP)

(21) Appl. No.: 19/103,835

(22) PCT Filed: Aug. 22, 2023
(86) PCT No.: PCT/IB2023/058344

§ 371 Date: Feb. 14, 2025

(30) Foreign Application Priority Data
Aug. 30, 2022 (JP) 2022-136439

(51) Int. Cl. H01R 12/73; H01R 12/71; H01R 13/03; H01R 13/6581

(52) U.S. Cl. CPC H01R 12/73; H01R 12/716; H01R 13/03; H01R 13/6581

(57) ABSTRACT

A conductive member includes a main body part, a board connecting part positioned at a first end of the main body part, and a contact point part positioned at a second end of the main body part, the main body part, board connecting part, and contact point part each include exposed surfaces exposed outside of a housing, the main body part, board connecting part, and contact point part each include a metal base material and first to third layers formed on the metal base material, and the first layer is a nickel or nickel alloy plating layer, the second layer is a platinum group metal or platinum group metal alloy plating layer, the third layer is a gold or gold alloy plating layer, the thickness of the second layer is 2 to 200 [nm], and the thickness of the third layer is 0.2 to 15 [nm].

### RELATED APPLICATIONS

This application claims the benefit of and priority to Japanese Patent Application No. 2022-136439 filed Aug. 30, 2022, the contents of which are incorporated by reference in their entirety herein.

### TECHNICAL FIELD

The present disclosure relates to a connector and a connector pair.

### BACKGROUND

Conventionally, board-to-board connectors have been used to electrically connect pairs of parallel circuit boards to each other. This manner of connector includes a plurality of terminals that are conductive members where a board connecting part of each terminal is connected by solder to a wiring pattern or the like formed on a circuit board, and when the connectors are mated and contact point parts of corresponding terminals come into contact with each other, the wiring patterns of the corresponding pair of circuit boards mutually conduct. Furthermore, a barrier is formed on each terminal to prevent spreading of melted solder from the board connecting part to the contact point part (for example, see Patent Document 1).

FIGS. 11A and 11B are diagrams depicting a conventional terminal, where FIG. 11A is a side view and FIG. 11B is a cross section view.

In the diagram, 861 is a terminal mounted in a housing of a connector (not depicted), a member formed by bending a narrow strip shaped conductive metal plate, and includes: a long narrow main body part 861c, a contact point part 861a formed at a first end of the main body part 861c for contacting a counterpart terminal, and a board connecting part 861b formed at a second end of the main body part 861c which is connected by solder to a wiring pattern or the like formed on the circuit board (not depicted).

Furthermore, as depicted in FIG. 11B, the contact point part 861a and the board connecting part 861b have a plurality of plating layers formed thereon. In the diagram, 862 is formed from a metal base material, for example, from a copper alloy such as beryllium copper. In addition, 863a is a nickel plating layer formed as a base layer on the metal base material 862 and the thickness thereof is roughly 2 [μm]. Furthermore, 863b is a palladium plating layer formed on the nickel plating layer 863a and, for example, is composed of a palladium alloy such as Pd—Ni alloy, and the thickness thereof is preferably 0.1 [μm] or more. Furthermore, 863c is a gold plating layer formed on the palladium plating layer 863b and, for example, is composed of a gold alloy such as Au—Co alloy, and the thickness thereof is preferably 0.3 [μm] or more.

As a result, for the contact point part 861a, electrical resistance can be reduced while hardness and wear resistance can be improved, and favorable contact reliability can be obtained. In addition, for the board connecting part 861b, favorable anti-corrosion and solder wettability can be maintained while hardness and wear resistance can be improved. Furthermore, the main body part 861c includes the nickel plating layer 863a and the palladium plating layer 863b formed on the nickel plating layer 863a, but there is no gold plating layer 863c.

In this manner, palladium plating layer 863b, which has inferior solder wettability relative to the gold plating layer 863c, is formed on the surface so the main body part 861c functions as a solder barrier so spreading of melted solder from the board connecting part 861b to the contact point part 861a can be prevented.

[PRIOR ART DOCUMENTS]; PATENT DOCUMENTS; [Patent Document 1] Japanese Unexamined Patent Application 2006-294420

### SUMMARY

However, with the conventional connector, a barrier must be formed between the board connecting part 861b and the contact point part 861a and a solder barrier must be formed over a broad area to fully prevent spreading of solder from the board connecting part 861b to the contact point part 861a and this increases the distance from the board connecting part 861b to the contact point part 861a, causing an increase in size of the terminal 861. In particular in recent years, board to board connectors have become smaller and lower in profile so increasing the size of the terminal 861 and lengthening the distance from the board connecting part 861b to the contact point part 861a is difficult. Since the size of the terminal 861 has been reduced in conjunction with size reduction and a lower profile of the board to board connector, the forming of a solder barrier between the board connecting part 861b and the contact point part 861a is difficult.

Herein, to resolve the conventional problems described above, an object is to provide a connector and connector pair having a simple structure, low cost, and high reliability that enable maintaining suitable solder wettability, improving connection strength with a board connecting part, and reducing contact resistance of the contact point part without forming a solder barrier.

To achieve this, a connector includes:
a housing, and a conductive member, wherein
the conductive member includes a main body part, a board connecting part positioned at a first end of the main body part, and a contact point part positioned at a second end of the main body part,
the main body part, board connecting part, and contact point part each include exposed surfaces exposed outside of the housing,
the main body part, board connecting part, and contact point part each include a metal base material and first to third layers formed on this metal base material, and
the first layer is a nickel or nickel alloy plating layer, the second layer is a platinum group metal or platinum group metal alloy plating layer, the third layer is a gold or gold alloy plating layer, the thickness of the second layer is 2 to 200 [nm], and the thickness of the third layer is 0.2 to 15 [nm].

In another connector, the thickness of the third layer is 0.5 to 8 [nm].

In still another connector, the platinum group metal is palladium or a palladium alloy.

In still another connector, the first to third layers are formed on an extension surface of the conductive member.

In still another connector, each of the exposed surfaces are formed contiguously with each other to form a single exposed surface.

In still another connector, the main body part, board connecting part, and contact point part are positioned on the same transverse plane extending in the mating direction.

In still another connector, the board connecting part and contact point part are positioned on the same straight line extending in the mating direction.

In still another connector, the conductive member is a plate shaped member and the board connecting part and contact point part are formed on an extension surface of the plate shaped member.

In still another connector, the area of the board connecting part is broader than the area of the contact point part.

In still another connector, the conductive member is a shield member surrounding the periphery of the connector.

In still another connector, the conductive member is a terminal for power or a terminal for signals.

In still another connector, the conductive member is a reinforcement fitting.

A connector pair includes a connector according to the present disclosure and a mating connector that mates with the connector.

The connector of the present disclosure enables maintaining suitable solder wettability, improving connection strength of the board connecting part, and reducing contact resistance of the contact point part without forming a solder barrier. In addition, the structure can be simplified, the cost can be reduced, and the reliability is improved.

### BRIEF DESCRIPTION OF THE DRAWINGS

FIG. 1 is a perspective view as viewed from the first connector side depicting the positional relationship between the first connector and the second connector prior to mating according to Embodiment 1.

FIG. 2 is an exploded view of the second connector according to Embodiment 1.

FIG. 3 is a cross section view when releasing the mating of the first connector and the second connector.

FIG. 4 is a schematic cross section view in the vicinity of the surface of the second terminal depicting a plating layer structure according to the present Embodiment.

FIG. 5 is a diagram depicting test results of solder wetting and spreading according to Embodiment 1.

FIG. 6 is a table depicting test results for changes to the thickness of the second and third layers in Embodiment 1.

FIG. 7 is a perspective view of a first connector and a second connector according to Embodiment 2 prior to mating.

FIG. 8 is a perspective view of the second connector according to Embodiment 2.

FIG. 9 is a plan view of a state in which the first connector and second connector according to Embodiment 2 are mated.

FIGS. 10A-10C are cross section views of the state in which the first connector and the second connector according to Embodiment 2 are mated, where FIG. 10A is a cross section view taken along the line A-A in FIG. 9, FIG. 10B is a cross section view taken along the line B-B in FIG. 9, and FIG. 10C is a cross section view taken along the line C-C in FIG. 9.

FIGS. 11A and 11B are diagrams depicting a conventional terminal, where FIG. 11A is a side view and FIG. 11B is a cross section view.

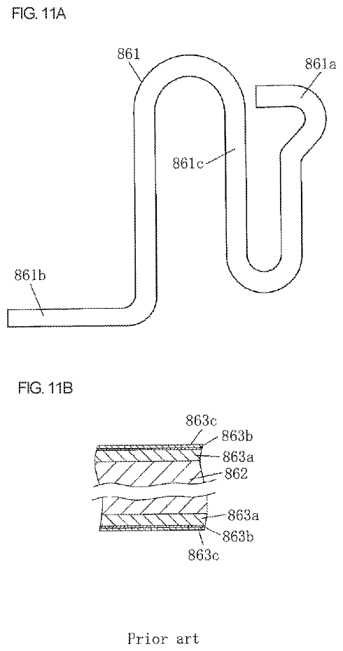

### DETAILED DESCRIPTION

Embodiments will hereinafter be described in detail with reference to the drawings.

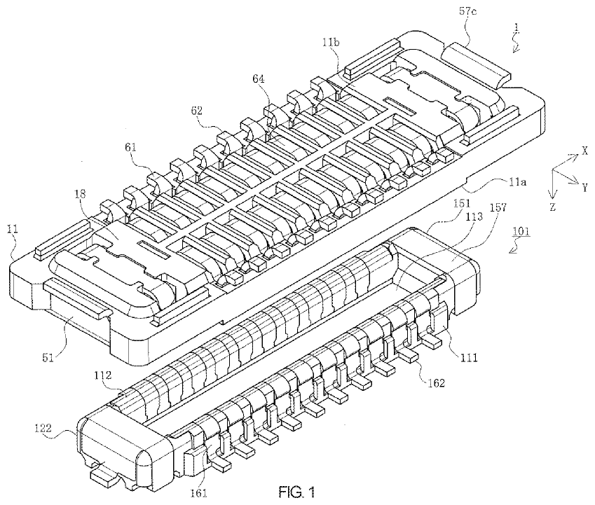

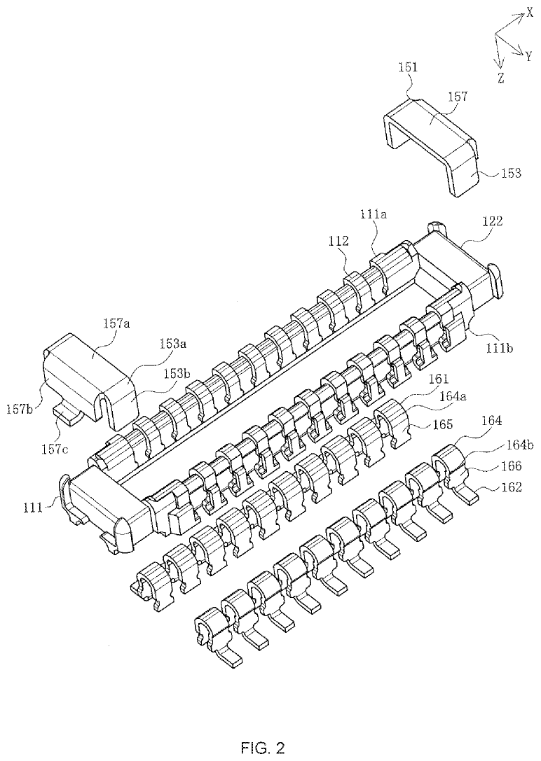

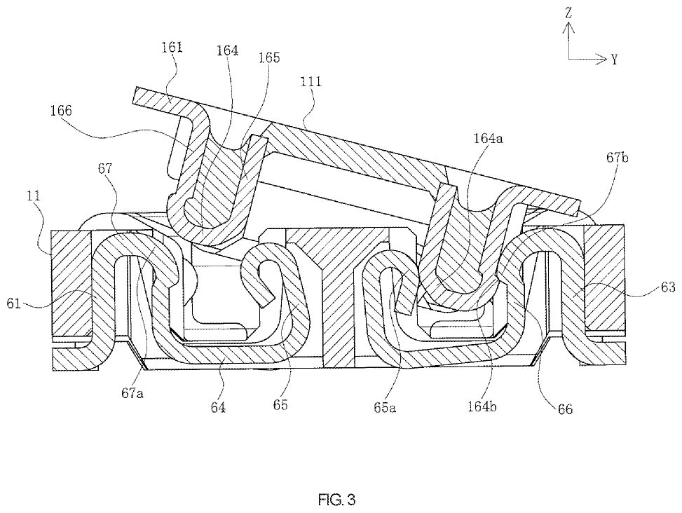

FIG. 1 is a perspective view as viewed from the first connector side depicting the positional relationship between the first connector and the second connector prior to mating according to Embodiment 1. FIG. 2 is an exploded view of the second connector according to Embodiment 1. FIG. 3 is a cross section view when releasing the mating of the first connector and the second connector.

In the drawings, 101 is a connector of the present Embodiment and represents a second connector as one of a pair of board to board connectors that are a connector pair. The second connector 101 is a surface-mounted connector mounted on the surface of a second board that is a mounting member (not illustrated), and is mated with a first connector 1 that is a counterpart connector. Furthermore, the first connector 1 is the other of the pair of board-to-board connectors and is a surface mount type connector mounted on the surface of a first board (not depicted) serving as a mounting member.

The first connector 1 and the second connector 101 according to the present embodiment are preferably used to electrically connect the first board to the second board, but can also be used to electrically connect other members. For example, the first board and the second board are each a printed circuit board, a flexible flat cable (FFC), a flexible circuit board (FPC), or the like as used in electronic devices or the like, but may be any type of board.

In addition, in the present embodiment, expressions indicating direction such as top, bottom, left, right, front, rear, and the like used to describe the configuration and operation of each part of the first connector 1 and the second connector 101 are relative rather than absolute and are appropriate when each part of the first connector 1 and the second connector 101 are in the positions depicted in the drawings; that said, these directions should be interpreted as changing in accordance with the change in position when the position thereof is changed.

Furthermore, the first connector 1 has a first housing 11 as a counterpart housing integrally formed of an insulating material such as synthetic resin. As depicted in the drawing, the first housing 11 is a substantially rectangular body having a substantially rectangular thick plate shape, wherein a recessed part that is a substantially rectangular recess surrounded by a periphery that mates with a second housing 111 of the second connector 101 is formed on the side in which the second connector 101 is inserted, that is, on the mating surface 11a side (Z-axis positive direction side). For example, the first connector 1 has dimensions of a length (a size in the X-axis direction) of about 6 mm, a width (a size in the Y-axis direction) of about 2 mm, and a thickness (a size in the Z-axis direction) of about 0.6 mm. However, the dimensions can be changed as appropriate. A first protruding part as an islet mated in the recessed groove part 113 of the second connector 101 is integrally formed with the first housing 11 in the recessed part, and a sidewall part extending parallel to the first protruding part is integrally formed with the first housing 11 on both sides (the side of the positive Y-axis direction and the side of the negative Y-axis direction) of the first protruding part.

A first terminal stowing internal cavity having a recessed groove shape is formed in side surfaces on both sides of the first protruding part. In addition, a first terminal stowing outer cavity having a recessed groove shape is formed in a side surface on the inside of the sidewall part. Furthermore, in the case the first terminal stowing internal cavity and the first terminal stowing outer cavity are collectively described, they are described as a first terminal stowing cavity. Note that the first terminal stowing cavity is formed so as to pass through the bottom plate 18 in the thickness direction (Z-axis direction).

In the present Embodiment, the first terminal stowing cavity is formed on both sides in the width direction (Y-axis direction) of the first housing 11 while arranged in the longitudinal direction of the first housing 11. Specifically, a plurality thereof (for example, 10) are formed at a prescribed pitch (for example, about 0.35 [mm]) on both sides of the first protruding part. Note that the pitch and the number of the first terminal stowing cavities can be changed as appropriate. Furthermore, a plurality of first terminals 61 serving as terminals which are stowed in each of the first terminal stowing cavities and installed on the first housing 11 are disposed on both sides of each first protruding part at the same pitch.

The first terminal 61 is a member integrally formed by performing processing such as punching and bending on a conductive metal plate, and includes a retained part 63 as a main body part, a tail part 62 as a board connecting part connected to a lower end of the retained part 63, an upper connecting part 67 connected to an upper end of the retained part 63, a second contact part 66 as a second contact point part facing the retained part 63 and connected to a lower end of the upper connecting part 67, a lower connecting part 64 connected to a lower end of the second contact part 66, and an inner connecting part 65 connected to an end of the lower connecting part 64 opposite the end the second contact part 66 is connected to. The first terminals 61 are fitted into the first terminal stowing cavities from the mounting surface 11b, which is the lower surface (Z-axis, negative direction surface) of the first housing 11, and the retained part 63 is sandwiched from both sides by the side walls of the first terminal housing outer cavities formed on the side surface inside the sidewall part so as to be fixed to the first housing 11.

Furthermore, a first contact part 65a as a first contact point part bent upwards approximately 180 degrees so as to protrude towards the second contact part 66 is connected to the upper end of the inner connecting part 65. In addition, the upper connecting part 67 includes an inclined part 67a that descends in a straight line from the upper end downward or with a gently curved shaped and a protruding part 67b at the lower end of the inclined part 67a protruding toward the inside of the first housing 11 in the width direction. In a state of the first terminal 61 being equipped in the first housing 11, the first contact part 65a and second contact part 66 are positioned on the left and right sides of the recessed groove part and face each other.

The first terminal 61 is a member integrally formed by processing a metal plate, and thus has a certain degree of elasticity. As is clear from this shape, the spacing between the first contact part 65a and the second contact part 66 may vary elastically. That is, when the second terminal 161 of the second connector 101 is inserted between the first contact part 65a and the second contact part 66, this causes the spacing between the first contact part 65a and the second contact part 66 to be elongated elastically. In addition, the tail part 62 is bent and connected to the retained part 63, extends outward in the left-right direction (Y-axis direction), in other words the width direction of the first housing 11, and is connected by soldering to a connection pad coupled to a conductive trace on the first board. Note that the conductive trace is typically a signal line but also may be a power line. In other words, the first terminal 61 may be a signal terminal or may be a power terminal.

Furthermore, a first protruding end part as a mating guide part is disposed on each of both longitudinal ends of the first housing 11. A mating recessed part is formed at each first protruding end part. Furthermore, in the state in which the first connector 1 and the second connector 101 are mated together, the second protruding end part 122 included in the second connector 101 is inserted into the mating recessed part.

In addition, a first reinforcement fitting 51 as a counterpart reinforcement fitting equipped on the first housing 11 is mounted on the first protruding end part. The first reinforcement fitting 51 includes a tail part 57c and contact arm part extending outward in the longitudinal direction of the first housing 11. The contact arm part comes into contact with a second reinforcement fitting 151 of the second connector 101 and the tail part 57c is connected by soldering to a connection pad coupled to a conductive trace on the first board. The conductive trace is typically a power line or a ground line.

Next, the configuration of the second connector 101 will be described.

The second connector 101 that is a connector according to the present embodiment has a second housing 111 that is a housing integrally formed of an insulating material such as synthetic resin. As depicted in the figure, the second housing 111 has a substantially rectangular thick plate-like shape that is a substantially rectangular parallelepiped. An elongated recessed groove part 113 extending in a longitudinal direction (X-axis direction) of the second housing 111 and a second protruding part 112 as an elongated protruding part demarcating an outside of the recessed groove part 113 and extending in the longitudinal direction of the second housing 111 are integrally formed on the side fitted in the first connector 1 of the second housing 111, in other words, on the side of a mating surface 111a (Z-axis negative direction side). The second protruding part 112 is formed along both sides of the recessed groove part 113 and along both sides of the second housing 111. For example, the second connector 101 has dimensions of a length of approximately 5.2 [mm], a width of approximately 1.9 [mm], and a thickness of approximately 0.5 [mm]. However, the dimensions can be changed as appropriate.

In addition, the second terminals 161 that are terminals are equipped in each of the second protruding parts 112 as conductive members. The same number of second terminals 161 as the first terminals 61 are disposed at a pitch corresponding to the first terminals 61. In the recessed groove part 113, the side mounted on the second board, in other words, the side of mounting surface 111b (Z-axis positive direction side) is closed by a bottom plate.

Furthermore, a second protruding end part 122 as a mating guide part is disposed on both ends in the longitudinal direction of the second housing 111. The second protruding end part 122 is a thick member extending in the width direction (Y-axis direction) of the second housing 111, where the two ends are connected to the two ends in the longitudinal direction of the second protruding parts 112, and the upper surface thereof has a substantially square shape. In a state in which the first connector 1 and the second connector 101 are mated together, the second protruding end part 122 functions as an insertion protrusion inserted into a mating recessed part of a first protruding end part provided in the first connector 1. In addition, a second reinforcement fitting 151 that is a reinforcement fitting is attached to the second protruding end part 122.

Note that the second terminal 161 and second reinforcement fitting 151 are members integrated by over-molding (insert molding) with the second housing 111 and so do not exist separately from the second housing 111 but for convenience of description, these are drawn separate from the second housing 111 in FIG. 2.

The second terminal 161 that is a conductive member is a member integrally formed by punching, bending, and the like processing of a conductive metal plate that is an elongated curvilinear member extending in the mating direction of the second connector 101 so the surface can be said to be an extension surface. Furthermore, the second terminal 161 includes a contact part 165 as a contact point part, a connecting part 164 connecting to an upper end of the contact part 165, a retained part 166 connected to an outer end of the connecting part 164, and a tail part 162 as a board connecting part connected to a lower end of the retained part 166. Note that in a comprehensive description, the retained part 166 and the connecting part 164 are described as the main body part.

The tail part 162 extends toward an outer side of the second housing 111 and is connected to a connection pad coupled to a conductive trace of the second board by soldering or the like. Note that the conductive trace is typically a signal line but also may be a power line. In other words, the second terminal 161 may be a terminal for signals or a terminal for power.

An inclined part 164a descending diagonally from the mating surface 111a side toward the mounting surface 111b in a relatively straight line or gently curved is formed on the contact part 165 of the connecting part 164. The protruding part 164b is formed on the retained part 166 side of the connecting part 164 protruding outward in the width direction of the second housing 111 at the boundary with the retained part 166.

In addition, the surfaces of the tail part 162, contact part 165, connecting part 164, and retained part 166 are exposed to each side surface of the second protruding parts 112 and the mating surface 111a. In other words, at least the tail part 162 that is the board connecting part, the contact part 165 that is the contact point part, and the protruding part 164b and retained part 166 that are the main body part include exposed surfaces that are exposed outside the second housing 111 and these exposed surfaces are formed mutually continuous, forming a single exposed surface.

Furthermore, as depicted in FIG. 3, the tail part 162 that is the board connecting part, the contact part 165 that is the contact point part, and the retained part 166 that is the main body part are positioned on a transverse plane extending in the mating direction of the first connector 1 and the second connector 101.

The second reinforcement fitting 151 is a member integrally formed by performing processing such as punching or bending on a conductive metal plate, and includes a center cover part 157 as a main body part covering the outside of the second protruding end part 122 and a side cover part 153 connected to both the left and right ends of the center cover part 157.

The center cover part 157 includes a protruding end upper cover part 157a extending in the width direction of the second housing 111 and covering a major portion of the upper surface of the second protruding end part 122, a connection cover part 157b that is bent approximately 90 degrees and connected to an outer end edge of the second protruding end part 122 in the protruding end upper cover part 157a, and a tail part 157c as the board connecting part that is bent and connected to the lower end of the connection cover part 157b and extends toward the outside in a front-to-back direction (X-axis direction), in other words, in the longitudinal direction of the second housing 111. The tail part 157c is connected to the connection pad coupled to the conductive trace of the second board by soldering or the like. The conductive trace is typically a power line or a ground line. Note that the tail part 157c may have an L shape extending outward in the short direction of the second housing 111.

In addition, the side cover part 153 includes a connection cover part 153a bent approximately 90 degrees and connected at both left and right ends to the protruding end upper cover part 157a and a side cover part 153b extending downward from the lower end of the connection cover part 153a. A side surface of the side cover part 153b functions as a contact point part and comes into contact with a contact arm part of a first reinforcement fitting 51. The lower end of the side cover part 153b is connected to a connection pad of the second board by soldering or the like. The connection pads are desirably coupled to a conductive trace of the second board that functions as a power line or a ground line.

The second reinforcement fitting 151 that is a conductive member is a member integrally formed by punching, bending, and the like processing of a conductive metal plate that is a member extending in the mating direction of the second connector 101 so the surface can be said to be an extension surface. Furthermore, the second reinforcement fitting 151 is provided with the side surface of the side cover part 153b as a contact point part and the lower end of the side cover part 153b as a board connecting part. Note that when described collectively, the area of the side cover part 153b from the contact location with the first reinforcement fitting 51 to the lower end thereof is described as the main body part.

Next, the operation of mating together the first connector 1 and the second connector 101 and the operation of releasing the mating with the above configuration will be described.

First, in the case of mating the first connector 1 and the second connector 101, the operator brings the mating surface 11a of the first housing 11 of the first connector 1 and the mating surface 111a of the second housing 111 of the second connector 101 into a state of facing each other, aligns the position of the second protruding part 112 of the second connector 101 with the position of the recessed groove part corresponding to the first connector 1, and aligns the position of the second protruding end part 122 of the second connector 101 with the position of the mating recessed part corresponding to the first connector 1 to complete alignment of the first connector 1 and second connector 101.

In this state, when the first connector 1 and/or the second connector 101 are moved in a direction approaching the counterpart, in other words, in the mating direction (Z-axis direction), the second protruding part 112 and the second protruding end part 122 of the second connector 101 are inserted into the recessed groove part and the mating recessed part of the first connector 1. Consequently, when the fitting between the first connector 1 and the second connector 101 is completed, the first terminal 61 and the second terminal 161 enter into a conduction state.

Specifically, the second terminal 161 of the second connector 101 is inserted between the first contact part 65a and the second contact part 66 of the first terminal 61, causing contact between the first contact part 65a of the first terminal 61 and the contact part 165 of the second terminal 161. As a result, the conductive traces coupled to the connection pads on the first board to which the tail parts 62 of the first terminals 61 are connected become conductive with the conductive traces coupled to the connection pads on the second board to which the tail parts 162 of the second terminals 161 are connected. Note that the protruding part 67b of the first terminal 61 engages with the protruding part 164b of the second terminal 161 ensuring the bond between the first terminal 61 and the second terminal 161 and ensures the mated state between the first connector 1 and the second connector 101 is maintained.

In addition, the second protruding end part 122 is inserted in the mating recessed part and the contact arm part of the first reinforcement fitting 51 comes into contact with the side cover part 153b of the second reinforcement fitting 151 attached to the second protruding end part 122. As a result, the conductive traces coupled to the connection pads on the first board to which the tail part 57c of the first reinforcement fitting 51 is connected becomes conductive with the conductive trace coupled to the connection pad on the second board to which the tail part 157c of the second reinforcement fitting 151 is connected.

Next, in the case of releasing the mutually mated first connector 1 and second connector 101, mating of the first connector 1 and the second connector 101 is ensured by mutual ensured joining of two rows of first terminals 61 lined up on both sides of the first protruding part of the first connector 1 and two rows of the second terminals 161 lined up on both sides of the recessed groove part 113 of the second connector 101; therefore, as depicted in FIG. 3, the second connector 101 should be inclined relative to the first connector 1 by rotating centered on the X-axis to release the first terminals 61 and second terminals 161 one row at a time. Note that FIG. 3 depicts a transverse plane extending in the mating direction of the first connector 1 and the second connector 101 as a cross section and depicts a state of the joining for only one row (row on left side of FIG. 3) of the first terminals 61 and second terminals 161 being in a released state.

After releasing the joining of the first row of first terminals 61 and second terminals 161, further rotation of the second connector 101 relative to the first connector 1 centered on the X-axis rotates (clockwise direction in the example depicted in FIG. 3) the second terminals 161 in the second row (row on the right side in FIG. 3) centered on the protruding parts 164b of the second terminals 161 engaged with the protruding parts 67b of the first terminals 61. Herein, the portion of the second terminal 161 where the contact part 165 is connected to the connecting part 164 is pressed against the first contact part 65a of the first terminal 61 protruding toward the second contact part 66 and this moves in an arc centered on the protruding part 164b and as an inclined part 164a having a relatively long straight line or gradual curve is formed in this portion, the movement is smooth with relatively little resistance. Therefore, the joining of the first terminals 61 and second terminals 161 in the second row can be released with application of a weaker force than for the joining of the first terminals 61 and second terminals 161 of the first row.

In other words, the amount of force required to release mating of the first connector 1 and second connector 101 has a first peak when releasing the joining of the first terminals 61 and second terminals 161 of the first row and a second peak when releasing the joining of the first terminals 61 and second terminals 161 of the second row. In the present Embodiment, the second terminals 161 include inclined part 164a having a relatively long straight line or gradual curve so the second peak is lower. Therefore, mating of the first connector 1 and second connector 101 can easily be released.

Next, the configuration of the plating layer formed on the extension surface that is the surface of the second terminal 161 and the second reinforcement fitting 151 that are conductive members, will be described.

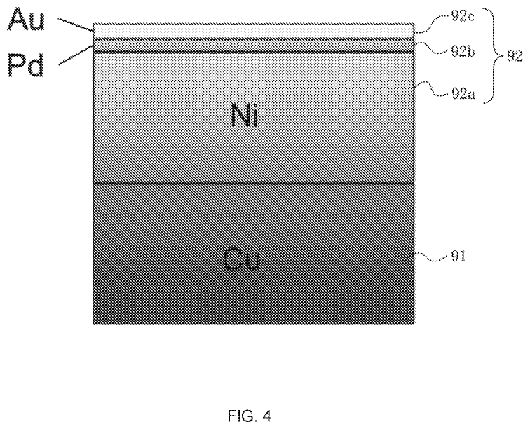

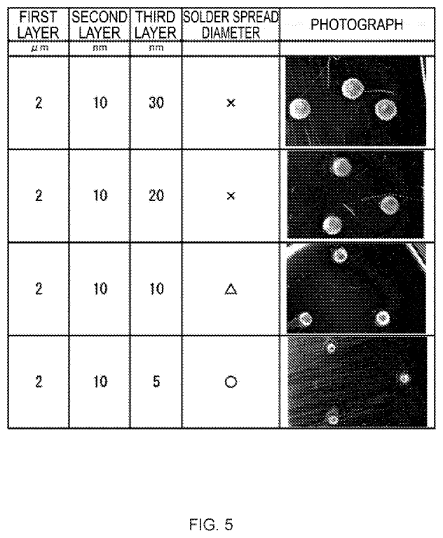

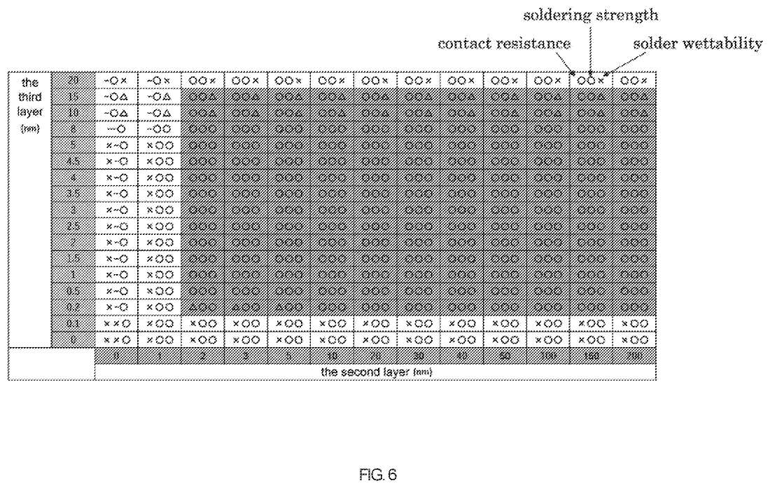

FIG. 4 is a schematic cross section view in the vicinity of the surface of the second terminal depicting a plating layer structure according to the present Embodiment; FIG. 5 is a diagram depicting test results of solder wetting and spreading according to Embodiment 1; and FIG. 6 is a table depicting test results for changes to the thickness of the second and third layers in Embodiment 1.

In the present Embodiment, the area near the surface over the entirety of the second terminal 161 that is the conductive member has the layer configuration as depicted in FIG. 4.

In the diagram, 91 is a conductive metal base material that constitutes the second terminal 161 and second reinforcement fitting 151 that are conductive members and, for example, are composed of copper (Cu) or a copper alloy.

In addition, 92 is a plating layer formed on the outer surface of the metal base material 91 and includes a first layer 92a, a second layer 92b, and a third layer 92c.

The first layer 92a is a nickel (Ni) or nickel alloy plating layer and the thickness thereof is preferably 1 to 3 [μm]. Note that the first layer 92a has the function of preventing diffusion of copper from the metal base material 91 to the second layer 92b and third layer 92c.

The second layer 92b is a platinum group metal or platinum group metal alloy plating layer and the thickness thereof is preferably 2 [nm] or more. Note that from a cost or the like perspective, the thickness is preferably 200 [nm] or less so the thickness can be said to be preferably 2 to 200 [nm]. Furthermore, from the perspective of sufficiently preventing mutual diffusion of the metal of the first layer 92a and the metal of the third layer 92c, the thickness thereof is more preferably 5 to 25 [nm]. In addition, any of ruthenium (Ru), rhodium (Rh), palladium (Pd), osmium (Os), iridium (Ir), or platinum (Pt) can be selected as the platinum group metal; however, the most preferred is palladium. Furthermore, examples of platinum group metal alloys include: any alloy containing 50 [%] or more of ruthenium, rhodium, palladium, osmium, iridium, or platinum; however, a palladium alloy containing 50 [%] or more of palladium (for example, PdNi or the like) is more preferable.

The third layer 92c is a gold or gold alloy plating layer and the thickness thereof is preferably 0.2 to 15 [nm] and more preferably 0.5 to 8 [nm]. In addition, examples of gold alloys include: gold alloys containing 90 [%] or more gold (for example, AuCo, AuCu, AuNi, AuFe, and the like). However, in the case of an alloy with a platinum group metal, a gold alloy with 20 [%] or more of gold (for example, AuPd, AuPt, or the like) is sufficient.

In the present Embodiment, the numerical range of the thicknesses of the second layer 92b and the third layer 92c are set based on experimental results (test results) such as those depicted in the table in FIG. 6. In FIG. 6, the horizontal axis indicates the numerical values [nm] of the thickness of the second layer 92b and the vertical axis indicates the numerical values [nm] of the thickness of the third layer 92c. In addition, each of the cells (boxes) of the table indicate test results of contact resistance tests, soldering strength tests, and solder wettability tests evaluated using one of the symbols O, Δ, and X. The symbol O means good, the symbol Δ means somewhat good, and the symbol x means failed.

In the experiment, a plating layer 92 was formed on the surface of each of the test pieces of a prescribed size composed of the metal base material 91 so as to achieve second layer 92b and third layer 92c thicknesses with a numerical value corresponding to each cell. Next, each of the test pieces were used to perform contact resistance tests, soldering strength tests, and solder wettability tests. Note that as depicted in FIG. 6, the thickness of the second layer 92b was varied from 0 to 200 [nm] and the thickness of the third layer 92c was varied from 0 to 20 [nm].

In the contact resistance test, the level of contact resistance on the plating layer 92 surface of each test piece was measured. The test pieces with a contact resistance less than a first threshold were evaluated as good, test pieces with a contact resistance above the first threshold but below a second threshold were evaluated as somewhat good, and test pieces with contact resistance above the second threshold were evaluated as failed.

In addition, in the soldering strength test, additional test pieces were soldered to the plating layer 92 surface of each test piece. A tensile force was applied to these separate test pieces and the tensile force causing the soldered portion to break was measured. Test pieces with a tensile force above a first threshold were evaluated as good, test pieces with a tensile force lower than the first threshold but above a second threshold were evaluated as somewhat good, and test pieces with a tensile strength less than the second threshold were evaluated as failed.

Furthermore, as depicted in FIG. 5, in the solder wettability test, several solder balls (for example, particle diameter approximately 0.6 [mm]) were placed on the surface of each test piece plating layer 92 and a heating device (for example, a solder reflow oven) was used, and the spread diameter after heating was measured. Test pieces where the spread diameter was less than a first threshold were evaluated as good, test pieces where the spread diameter were greater than the first threshold but less than a second threshold were evaluated as somewhat good, and test pieces with a spread diameter greater than the second threshold were evaluated as failed.

As depicted in FIG. 6, in the experimental results, there were no failures in test result evaluation for a second layer 92b thickness in the range of 2 to 200 [nm] and a third layer 92c thickness in the range of 0.2 to 15 [nm] and so can be used as the second terminal 161 that is a conductive member. Furthermore, when the thickness of the third layer 92c was restricted to the range of 0.5 to 8 [nm], the test results did not include failure or somewhat good evaluation, in other words, the test result evaluation was good for all cases; therefore, this was found to be more desirable. Note that from FIG. 6, it is anticipated that test result evaluations will all be good for a second layer 92b thickness of greater than 200 [nm], but when considering cost and the like, a value greater than 200 [nm] is not realistic so the upper limit of the thickness of the second layer 92b was set to 200 [nm].

As depicted in FIG. 5, if the thickness of the third layer 92c that is a gold or gold alloy plating layer is thin, the spread diameter of solder is reduced, in other words, the wettability of solder is reduced, suppressing spreading of solder and preventing spreading of solder to the contact part 165 that is the contact point part. On the other hand, when wettability is reduced, soldering the tail part 162 is difficult, and strength of the soldered portion is reduced leading to reduced soldering strength of the tail part 162 on the second board surface. In addition, if the thickness of the third layer 92c that is a gold or gold alloy plating layer is thin, contact resistance increases and in addition, the third layer 92c wears more readily. However, forming the second layer 92b that is a platinum group metal or platinum group metal alloy plating layer below the third layer 92c with a prescribed thickness or thicker, enables reducing the contact resistance of the third layer 92c and also prevents wear.

In this manner, by setting the thickness of the third layer 92c to 0.2 to 15 [nm] and the thickness of the second layer 92b below the third layer 92c to 2 to 200 [nm], solder wettability can be suitably maintained, connection strength of the tail part 162 can be improved, while solder spread can be suppressed and contact resistance of the contact part 165 can be reduced without forming a solder barrier.

Note that in the present Embodiment, the thicknesses of the second layer 92b and third layer 92c were measured using X-ray electron spectroscopy, commonly known as XPS. XPS is a method for measuring components of a sample and in general can measure substances with a depth of roughly 0.2 to 6 [nm]. In addition, the sample surface layer is scraped by ion sputtering (sputter etching using ions). Ion sputtering can be used to scrape roughly 0.2 to 1 [nm]. Note that the amount of scraping can be adjusted.

In the present Embodiment, measurement was performed by repeating the operations of measuring a sample surface substance using XPS, scraping the surface layer of the sample using ion sputtering, and measuring a sample surface substance using XPS. For example, after measuring the third layer 92c that is the surface layer using XPS and detecting gold or gold alloy, just 0.2 [nm] of the third layer 92c that is the surface is scraped using ion sputtering; next, in measuring using XPS, if gold or gold alloy can be detected, the thickness of the third layer 92c composed of gold or gold alloy can be determined to be 0.2 [nm] or more.

In this manner, in the present Embodiment, the second connector 101 includes a second housing 111 and second terminal 161. Furthermore, the second terminal 161 includes a retained part 166 and connecting part 164, a tail part 162 positioned at a first end of the retained part 166, and a contact part 165 positioned at a second end of the connecting part 164; where the retained part 166 and connecting part 164, tail part 162, and contact part 165 each include exposed surfaces exposed outside of the second housing 111; the retained part 166 and connecting part 164, tail part 162, and contact part 165 each include a metal base material 91 and a first layer 92a, second layer 92b, and third layer 92c formed on the metal base material 91; the first layer 92a is a nickel or nickel alloy plating layer, the second layer 92b is a platinum group metal or platinum group metal alloy plating layer, the third layer 92c is a gold or gold alloy plating layer, the thickness of the second layer 92b is 2 to 200 [nm], and the thickness of the third layer 92c is 0.2 to 15 [nm].

Thus, solder wettability can be suitably maintained enabling improving the connection strength of the tail part 162 and prevention of solder spread and reduction of contact resistance of the contact part 165 can be achieved without forming a barrier. Therefore, a solder barrier no longer needs to be formed for second terminals 161 of very small size used for an extremely small and low profile second connector 101; enabling simplifying the structure of the second connector 101, reducing cost, and improving reliability.

In addition, the thickness of the third layer 92c is preferably 0.5 to 8 [nm]. Furthermore, the platinum group metal is preferably palladium or palladium alloy. Furthermore, the first layer 92a, the second layer 92b, and the third layer 92c are formed on the extension surface of the second terminal 161. Furthermore, each of the exposed surfaces is formed contiguously and so form a single exposed surface. Furthermore, the retained part 166 and connecting part 164, tail part 162, and contact part 165 are positioned on the same transverse plane extending in the mating direction. Furthermore, the side surface and lower end of the side cover part 153b of the second reinforcement fitting 151 are positioned on the same straight line extending in the mating direction.

Next, Embodiment 2 will be described below. Note that, for portions having the same structure as that of Embodiment 1, descriptions thereof are omitted by giving the same reference numerals thereto. Moreover, descriptions of the same operations and effects as those of Embodiment 1 will be omitted.

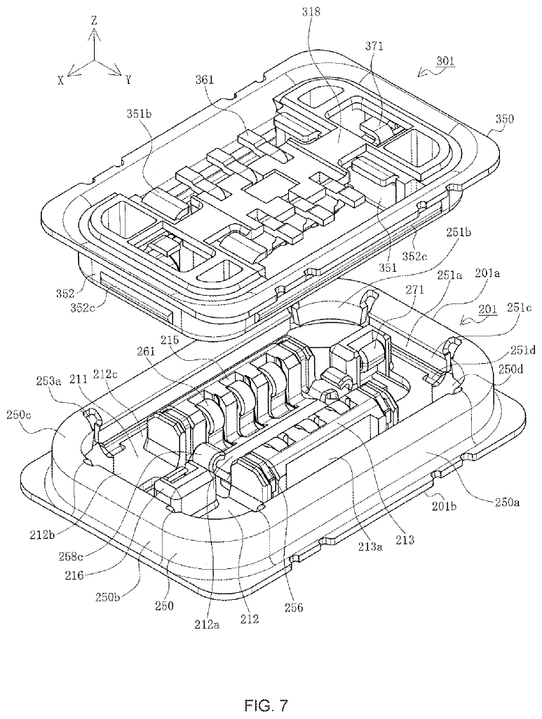

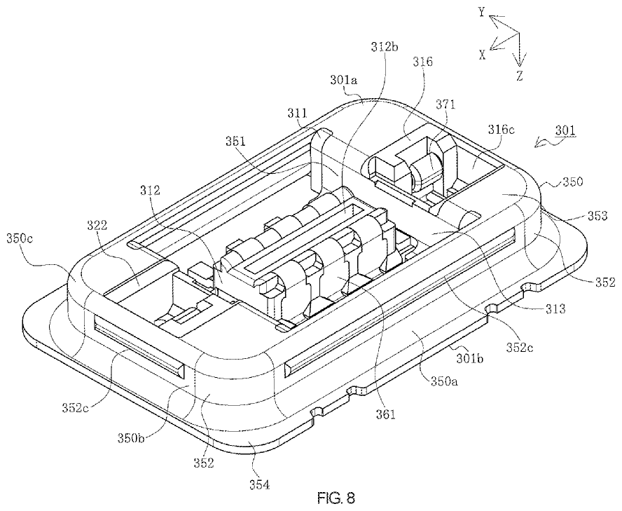

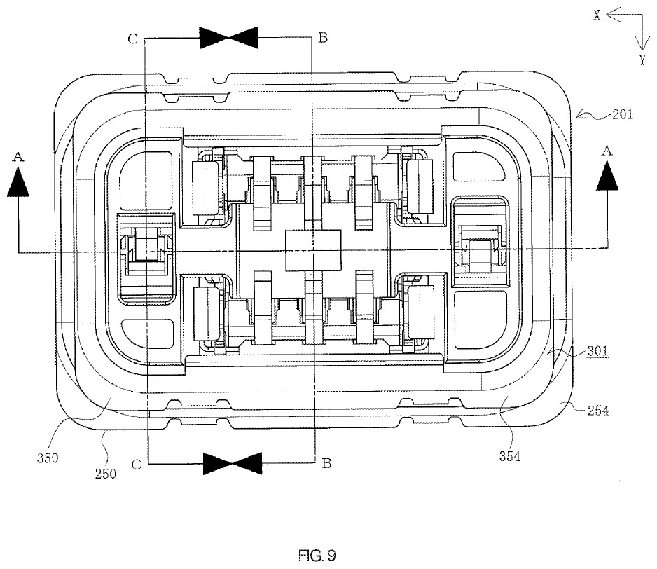

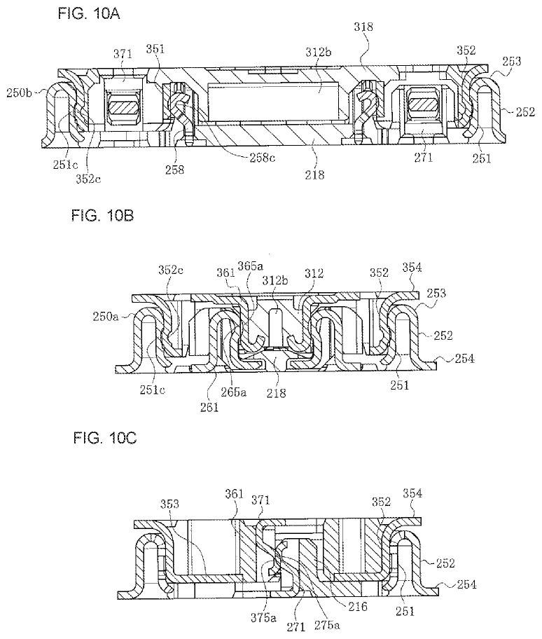

FIG. 7 is a perspective view of a first connector and a second connector according to Embodiment 2 prior to mating. FIG. 8 is a perspective view of the second connector according to Embodiment 2. FIG. 9 is a plan view of a state in which the first connector and second connector according to Embodiment 2 are mated. FIGS. 10A-10C are cross section views of a state in which the first connector and second connector according to Embodiment 2 are mated. Note that in FIGS. 10A-10C, FIG. 10A is a cross section view taken along the line A-A in FIG. 9, FIG. 10B is a cross section view taken along the line B-B in FIG. 9, and FIG. 10C is a cross section view taken along the line C-C in FIG. 9.

In the drawings, 201 represents a first connector as one of a pair of substrate-to-substrate connectors, which are connectors in the present embodiment. The first connector 201 is a surface mounting type receptacle connector mounted on a surface of a first board (not shown) serving as a mounting member, and is mated together with a second connector 301 serving as a counterpart connector. In addition, the second connector 301 is the other of the pair of board-to-board connectors and is a surface mounting type plug connector mounted on a surface of a second board (not shown) serving as a mounting member.

Note that the first connector 201 and the second connector 301 of the connector pair according to the present Embodiment are preferably used to electrically connect the first board to the second board but can also be used to electrically connect other members. For example, the first board and the second board are each a printed circuit board, a flexible flat cable, a flexible circuit board, or the like as used in electronic devices or the like, but may be any type of board.

Furthermore, in the present Embodiment, expressions indicating direction such as up, down, left, right, front, rear, and the like used to describe a configuration and operation of each part of the connector pair first connector 201 and the second connector 301 are relative rather than absolute and are appropriate when each part of the first connector 201 and the second connector 301 are in positions depicted in the drawings. However, these directions should be interpreted as changing in accordance with a change in position when the position thereof is changed.

Furthermore, the first connector 201 has: a first shield 250 as a first outer side shield, which is a receptacle shield formed by punching, drawing, or the like process on a conductive metal plate; and a first housing 211 as a counterpart housing integrally formed by an insulating material such as a synthetic resin or the like. The first housing 211 has: a flat bottom plate 218; and first protruding parts 213 serving as a pair of protrusions protruding upwardly from an upper surface of the bottom plate 218. The first protruding parts 213 as a whole are positioned more to an inner side in a width direction (Y-axis direction) of the first connector 201 than two side ends of the bottom plate 218.

Each of the first protruding parts 213 is an essentially rectangular member extending in a longitudinal direction (X-axis direction) of the first connector 201, and a plurality of first terminal stowing cavities 215 (three in the example depicted in the drawings) are formed in the longitudinal direction at a prescribed pitch (for example, 0.35 [mm]) from inside surfaces facing each other to an upper surface. Note that the pitch and the number of the first terminal stowing cavities 215 can be changed as appropriate. Furthermore, a plurality of first terminals 261 serving as terminals which are housed in each of the first terminal stowing cavities 215 and installed on the first housing 211 are disposed on two sides of each of the first protruding parts 213 at the same pitch. In other words, a plurality of the first terminals 261 are disposed along each first protruding part 213 to form a pair of parallel terminal group rows. Note that the first terminal stowing cavity 215 is formed so as to penetrate the bottom plate 218 in the plate thickness direction (Z-axis direction).

In addition, shield plate stowing slits are formed as slits in the vicinity of both ends of the first protruding part 213 in the longitudinal direction and a shield plate 256 is stowed as a first inner shield in this shield plate stowing slit. In the example depicted in the drawings, the shield plate stowing slit extends continuously from the upper surface of the first protruding part 213 to the inside surface and the outer surface, and is further formed so as to penetrate the bottom plate 218 in the plate thickness direction from the inside surface and outer surface. Note that the bottom plate 218 between the first protruding parts 213 is a thick wall part whose thickness (dimension in the Z-axis direction) is thicker than other locations, and an opening penetrating in the plate thickness direction is formed at a position corresponding to the shield plate stowing slits and in the vicinity thereof with regard to the longitudinal direction of the first connector 201.

In addition, in an outer side in the width direction of the first connector 201 in the first protruding part 213, an outer side recess 213a is formed, which recesses inwardly, in a range closer to a center in the longitudinal direction than the shield plate stowing slits. The outer side recess 213a is formed so as to extend in a vertical direction (Z-axis direction) from the upper surface of the first protruding part 213 to the lower surface of the bottom plate 218, such that the bottom plate 218 is not present on the outer side in the width direction of the first connector 201 from the outer side recess 213a.

Furthermore, first high-frequency terminal supporting parts 216 serving as a pair of supporting parts protruding upwardly from the upper surface of the bottom plate 218 are formed more on an outer side of the shield plate stowing slit with regard to the longitudinal direction of the first connector 201. The first high-frequency terminal supporting part 216 includes a first high-frequency terminal stowing groove as a high-frequency terminal stowing groove extending in the vertical direction. Furthermore, a first high-frequency terminal 271 is stowed in this first high-frequency terminal stowing groove as a high-frequency terminal. Furthermore, a first high-frequency terminal stowing opening serving as an opening penetrating the bottom plate 218 in the plate thickness direction is formed below and in front of the first high-frequency terminal stowing groove.

Furthermore, a connecting end, which is connected to the first shield 250, is present at an outermost end of the bottom plate 218 with regard to the longitudinal direction and the width direction of the first connector 201. The first shield 250 is integrated with the first housing 211 by over-molding or insert molding. In other words, the first housing 211 is molded by filling a cavity of a mold, in which the first shield 250 is set inside in advance, with an insulating material such as synthetic resin or the like, and is integrally connected to the first shield 250 at the connecting end.

The first shield 250 is a member integrally formed by punching, drawing, or the like process on a conductive metal plate, and is an essentially rectangular frame-like member when viewed from above, in other words, in plan view, which surrounds an entire circumference of the first housing 211. Furthermore, with the present Embodiment, the first shield 250 includes a pair of long side parts 250a extending in a straight line in the longitudinal direction of the first connector 201, a pair of short side parts 250b extending in a straight line in the width direction of the first connector 201, and four corner parts 250c bent at approximately 90 degrees that connect ends of the long side parts 250a to ends of the short side parts 250b, that are members functioning as a conductive member.

Furthermore, the first shield 250 contains: an outer wall 252; an inner wall 251 essentially parallel to the outer wall 252 on an inner side of the outer wall 252; and a coupling part 253 that connects and integrates an upper end of the outer wall 252 with an upper end of the inner wall 251. While the outer wall 252 is a continuous wall over an entire circumference, the inner wall 251 is separated into a linear part 251a and a curved part 251b by slit parts 253a formed at two ends of each corner part 250c. The linear part 251a is a linear portion in plan view and corresponds to the long side part 250a and the short side part 250b. Furthermore, the curved part 251b is a curved portion in plan view and corresponds to the corner part 250c. Note that the slit part 253a is a notch that starts at an upper end of the coupling part 253, extends downwardly through the inner wall 251, and is opened at a lower end of the inner wall 251. Therefore, in the coupling part 253, a portion adjacent to the outer wall 252 is continuous over an entire circumference, while a portion adjacent to the inner wall 251 is separated by the slit part 253a into portions corresponding to the long side part 250a and the short side part 250b and a portion corresponding to the corner part 250c. Note that an enclosed space surrounded on the circumference by the portions corresponding to the long side part 250a, the short side part 250b and the corner part 250c of the inner wall 251 is a stowing part 250d in which the second connector 301, which is a plug connector, is inserted and stowed.

Furthermore, the linear part 251a of the inner wall 251 has: a bent end part 251d connected to a lower end thereof; and an engaging recessed part 251c formed above the bent end part 251d. The bent end part 251d is a portion bent such that a tip end thereof points inward diagonally and downward of the stowing part 250d, and the connecting end of the bottom plate 218 is connected to a portion thereof. In other words, the linear part 251a is connected to the first housing 211. In contrast, the curved part 251b does not have the bent end part 251d and is not connected to the first housing 211.

The engaging recessed part 251c functions as a contact point part, and is a portion that engages and comes into contact with an engaging protruding part 352c formed on an outer wall 352 of a second shield 350 provided on the second connector 301 when the first connector 201 and second connector 301 are mated together, and extends linearly in the longitudinal direction and the width direction of the first connector 201. As described above, each linear part 251a is relatively flexible and can be elastically deformed in a direction of approaching or separating from the outer wall 252, since two ends are separated from the other portion by the slit part 253a. Note that the engaging recessed part 251c is formed in a recessed shape to enable engaging with the engaging protruding part 352c; however, the lower end of the linear part 251a of the inner wall 251 may extend to the upper end of the bent end part 251d and this extended area may function as a contact point part with the engaging protruding part 352c. On the contrary, in the case that the outer wall 352 of the second shield 350 is not provided with the engaging protruding part 352c, an engaging protruding part may be formed on the inner wall 251 in place of the engaging recessed part 251c, functioning as a contact point part with the outer wall 352.

A flange part 254 serving as an outwardly extending flat part is connected to the lower end of the outer wall 252 through the bent part bent at an angle of approximately 90 degrees. The bent part and the flange part 254 are connected to the lower end of the outer wall 252 in a continuous manner around the entire periphery.

The flange part 254 functions as a board connecting part, a lower surface of which is parallel to the surface of the first board and is a portion connected by soldering or the like to the connection pad on the surface. The connection pad is typically connected to a ground line. Furthermore, in addition to being continuous around the entire periphery, the outer wall 252 has an upper end thereof connected to a coupling part 253, a lower end thereof connected to the flange part 254, and therefore has relatively high rigidity, and does not readily deform. In the present Embodiment, an example is described where the flange part 254 is connected to the lower end of the outer wall 252 continuously over the entire circumference, but the flange part may be connected only to a portion if relatively high rigidity is not required.

The first shield 250, which is a conductive member, is a member integrally formed by punching, drawing, and the like processing of a conductive metal plate that is a curvilinear member extending in the mating direction of the first connector 201 so the surface can be said to be an extension surface. Furthermore, the first shield 250 includes an engaging recessed part 251c as a contact point part, a coupling part 253 connected to the upper end of the inner wall 251 that forms the engaging recessed part 251c, an outer wall 252 with an upper end connected to the coupling part 253, and a flange part 254, with a lower end connected to the outer wall 252, as a board connecting part. Note that in a collective description, the area of the inner wall 251 from the engaging recessed part 251c to the lower end of the outer wall 252, including the coupling part 253, is described as a main body part. With the present Embodiment, the plating layer 92 including the first, second and third layers 92a, 92b, and 92c are formed on the extension surface of the first shield 250, which is a conductive member.

Furthermore, when the first housing 211 is connected to the first shield 250 in the stowing part 250d, a first recessed part 212 that mates with the second connector 301 is formed in the stowing part 250d, which is a recess with a circumference surrounded by the inner wall 251 and a lower portion that is demarcated by the bottom plate 218. Furthermore, an inner recessed groove part 212a, which is an elongated recessed part extending in the longitudinal direction of the first connector 201, is formed between the pair of first protruding parts 213 as a portion of the first recessed part 212. Furthermore, an outer recessed groove part 212c, which is an elongated recessed part extending in the longitudinal direction of the first connector 201, is formed between the first protruding parts 213 and the inner wall 251 as a portion of the first recessed part 212. Furthermore, mating recessed parts 212b are formed at two outer ends of the first protruding part 213 with regard to the longitudinal direction of the first connector 201 as a portion of the first recessed part 212.

The first terminal 261 is a member integrally formed by punching, bending, or the like process on a conductive metal plate, and has: a retained part; a tail part serving as a board connecting part connected to a lower end of the retained part; an upper connecting part connected to an upper end of the retained part; and a lower connecting part connected to a lower end of the upper connecting part. Furthermore, a bent contact part 265a is formed in the vicinity of a lower end of the upper connecting part so as to bulge inward in the width direction of the first connector 201. The contact part 265a functions as a contact point part and is the portion that comes into contact with a second terminal 361 provided on the second connector 301.

Note that the first terminal 261 is not necessarily attached to the first housing 211 by press fitting, but may be integrated with the first housing 211 by over-molding or insert molding. Herein, for convenience of description, a case in which the retained part is pressed into and retained by the first terminal stowing cavity 215 will be described.

In addition, the tail is connected to the connection pad coupled to the conductive trace of the first board by soldering or the like. Note that the conductive trace may be a power line that supplies power, but is typically a signal line. In addition, the signal line is described assuming that the signal line does not transmit a high-frequency signal, but rather transmits a signal of normal frequency (for example, frequency less than 10 [GHz]), which is lower in frequency than high-frequency signals.

The first terminal 261 is inserted from a mounting surface 201b that is the lower surface (Z-axis, negative direction surface) of the first connector 201 into the first terminal stowing cavity 215, and is secured in the first housing 211. In this state, in other words, in a state in which the first terminals 261 are installed in the first housing 211, the contact parts 265a protrude from an inside surface of the first protruding parts 213 into the inner recessed groove parts 212a and face each other.

The first high-frequency terminal 271 is a member integrally formed by punching, bending, and the like processing of a conductive metal plate that is an elongated curvilinear member extending in the mating direction of the first connector 201 so the surface can be said to be an extension surface. In addition, the first high-frequency terminal 271 includes a retained part, a tail part connected to the lower end of the retained part as a board connecting part, and an upper connecting part connected to the upper end of the retained part. In addition, the upper connecting part is bent in an approximate S-shape when viewed from the longitudinal direction of the first connector 201, and a portion bent so as to bulge out toward the center in the width direction of the first connector 201 is a contact part 275a. The contact part 275a functions as a contact point part and is the portion that comes into contact with a second high-frequency terminal 371 provided on the second connector 301.

Note that the first high-frequency terminal 271 is not necessarily attached to the first housing 211 by press fitting but may be integrated with the first housing 211 by over-molding or insert molding. Herein, for convenience of description, a case in which the retained part is pressed into and retained by the first high-frequency terminal stowing groove of the first high-frequency terminal supporting part 216 will be described.

In addition, the tail is connected to the connection pad coupled to the conductive trace of the first board by soldering or the like. Note that the aforementioned conductive traces are signal lines, which are typically described as transmitting high-frequency signals of high-frequency (for example, frequency of 10 [GHz] or higher), such as RF signals.

The first high-frequency terminal 271 is press-fit from the mounting surface 201b into the first high-frequency terminal stowing groove of the first high-frequency terminal supporting part 216 positioned in a mating recessed part 212b and secured to the first housing 211. In this state, in other words, in a state in which the first high-frequency terminals 271 are installed in the first housing 211, the contacting parts 275a of the pair of first high-frequency terminals 271 face mutually opposite directions.

The shield plate 256 is a member integrally formed by punching, bending, or the like process on a conductive metal plate, and has: a center part 258; and a pair of side parts connected to two sides of the center part 258. The center part 258 bulges outward in the longitudinal direction of the first connector 201, the tip thereof bulges outward in the longitudinal direction of the first connector 201, and the outer surface includes a contact part 258c. The contact part 258c functions as a contact point part and comes into contact with an inner wall 351 of the second shield 350 provided on the second connector 301. In addition, the lower end of the side part functions as a tail part, which is a board connecting part, and is a portion that is connected to a connection pad of the first board by soldering or the like. The connection pad is typically connected to a ground line.

Note that the shield plate 256 is not necessarily attached to the first housing 211 by press fitting, but may be integrated with the first housing 211 by over-molding or insert molding. Herein, for convenience of description, a case in which the shield plate 256 is retained by being press-fitted into the shield plate stowing slits will be described.

The shield plate 256 that is a conductive member is a member integrally formed by punching, bending, and the like processing of a conductive metal plate that is a member extending in the mating direction of the second connector 301 so the surface can be said to be an extension surface. Furthermore, the shield plate 256 includes a contact part 258c as a contact point part and a lower end as a board connecting part. Note that when collectively described, the area of the shield plate 256 from the contact part 258c to the lower end is described as the main body part. With the present Embodiment, the plating layer 92 including the first, second and third layers 92a, 92b, and 92c are formed on the extension surface of the shield plate 256, which is a conductive member.

Furthermore, the first connector 201 is placed on the surface of the first board with a first solder sheet (not shown) serving as a solder sheet applied to the mounting surface 201b side and is fixed and mounted on the surface of the first board by heating and melting the first solder sheet using a heating furnace or the like. Note that the means for connecting the first shield 250, first terminal 261, first high-frequency terminal 271, shield plate 256, and the like to the connection pad or the like of the first board does not necessarily have to be application of a solder sheet, and may be application of solder paste, transfer of cream solder, dipping, jet soldering, or the like; however, for convenience of description, the case of using a solder sheet will be described.

The solder sheet includes a pair of elongated strip shaped long side portions extending continuously in a straight line in the longitudinal direction of the first connector 201 and a pair of elongated strip shaped short side portions extending continuously in a straight line in the width direction of the first connector 201. Furthermore, a pair of long side portions are attached to the bottom surface of the flange part 254 corresponding to the long side parts 250a of the first shield 250. A pair of short side portions are attached to the bottom surface of the flange part 254 corresponding to the short side parts 250b of the first shield 250. Note that specific details regarding soldering of the first terminal 261, first high-frequency terminal 271, and shield plate 256 are omitted.

When the first connector 201 is mounted on the surface of the first board by heating and melting a first solder sheet applied in this manner, the flange part 254, which is connected continuously around the entire periphery, is connected without a gap to connection pads on the surface of the first board at the bottom of the outer wall 252, which is connected continuously around the entire periphery, of the first shield 250 that is a conductive member. Therefore, the strength of the first shield 250 connected to the connection pads on the surface of the first board is high, and consequently, the strength of the entire first connector 201 with an outer circumference surrounded by the first shield 250 is high. Furthermore, an electromagnetic shielding effect exerted by the first shield 250, which is connected without a gap to the connection pads on the surface of the first board, is very high, and the first connector 201 with an outer circumference surrounded by the first shield 250 is very effectively electromagnetically shielded. In particular, the smoothness of the lower surface of the flange part 254 is high. Thus, the strength of the first shield 250 connected to the connection pads on the surface of the first board can be made extremely high. Moreover, since no gap is created between the connection pads on the surface of the first board, the electromagnetic shielding effect can also be made extremely high. In addition, the area of the flange part 254 is set broader than the area of the engaging recessed part 251c that is a contact point part, to fully ensure soldering connection.

Thus, the first connector 201 can transmit a high-frequency signal even with a compact and low profile, because the strength and the electromagnetic shielding effect are high. For example, even if the dimensions in the longitudinal, width, and height directions of the first connector 201 are set to 3.3 [mm] or less, 2.3 [mm] or less, and 0.6 [mm] or less, the first high-frequency terminal 271 can transmit a high-frequency signal of approximately 60 [GHz].

Next, the configuration of the second connector 301 will be described.

The second connector 301 according to the present Embodiment includes: a second shield 350 as a second outer side shield, which is a plug shield formed by punching, drawing, or the like process on a conductive metal plate; and a second housing 311 as a counterpart housing integrally formed using an insulating material such as a synthetic resin or the like. The second housing 311 has: a flat bottom plate 318; a second protruding part 312 serving as a protrusion protruding upwardly from an upper surface of a bottom plate 318 in a center in a longitudinal direction of the second connector 301; and a pair of protruding end parts 322 protruding upwardly from the upper surface of the bottom plate 318 at two ends in the longitudinal direction (X-axis direction) of the second connector 301. The second protruding part 312 is narrower than the protruding end part 322 and is positioned more on an inner side in a width direction (Y-axis direction) of the second connector 301 than two ends of the protruding end part 322.

The second protruding part 312 is an essentially rectangular member extending in the longitudinal direction of the second connector 301. An elongated groove shaped center slit 312b recessed downwardly from an upper surface is formed in a center in the width direction, and portions on two sides on the left and right of the center slit 312b are terminal supporting walls supporting the second terminal 361 serving as a mating terminal. The second terminal 361 is disposed on an outer surface of the terminal support wall at a pitch and number corresponding to the first terminal 261. In other words, a plurality of the second terminals 361 are disposed along both sides of the second protruding part 312 to form a pair of parallel terminal group rows (mating terminal group rows).

Each of the protruding end parts 322 is separated from two ends in the longitudinal direction of the second protruding part 312. Furthermore, a second high-frequency terminal supporting part 316 serving as a supporting part is formed on each protruding end part 322. The second high-frequency terminal supporting part 316 includes a second high-frequency terminal stowing groove that extends vertically, having a substantially U shape when viewed from above. In addition, the second high-frequency terminal supporting parts 316 are disposed such that openings of the respective second high-frequency terminal stowing grooves facing opposite directions are disposed so as to be point-symmetrical with regard to a center of the second connector 301 when viewed from above, in other words, in plan view, and so as to be separated from the center of the second connector 301 in the width direction and deflected to an outer side in the width direction. Furthermore, a second high-frequency terminal 371 serving as a high-frequency terminal is stowed in the second high-frequency terminal stowing grooves. Furthermore, a second high-frequency terminal stowing opening serving as an opening penetrating the bottom plate 318 in the plate thickness direction is formed below and in front of the second high-frequency terminal stowing groove. Furthermore, on each of the protruding end parts 322, a first high-frequency terminal stowing recessed part 316c, serving as a mating terminal stowing recessed part opened in an upper surface from the second high-frequency terminal stowing opening to the upper surface, is formed in front of the second high-frequency terminal stowing groove.

The second shield 350 is a member integrally formed by punching, drawing, or the like process on a conductive metal plate and is an essentially rectangular frame-like member in plan view, and surrounds the entire circumference of the second housing 311. Furthermore, with the present Embodiment, the second shield 350 includes a pair of long side parts 350a extending in a straight line in the longitudinal direction of the second connector 301, a pair of short side parts 350b extending in a straight line in the width direction of the second connector 301, and four corner parts 350c bent at approximately 90 degrees that connect ends of the long side parts 350a to ends of the short side parts 350b, that are members functioning as a conductive member.

Furthermore, the second shield 350 contains: an outer wall 352; an inner wall 351 serving as a second inner second inner side shield; and an upper wall 353. Furthermore, the outer wall 352 is a continuous wall over the entire circumference. Furthermore, the upper wall 353 is connected to an upper end of the outer wall 352 at each of the short side parts 350b, the corner parts 350c at two ends of the short side parts 350b, and in the vicinity of two ends of each of the long side parts 350a and is formed so as to cover at least a portion, preferably a majority, of the upper surface of the protruding end part 322. Note that the upper wall 353 has an opening corresponding to the first high-frequency terminal stowing recessed part 316c. Furthermore, the inner wall 351 extends downwardly with an upper end thereof connected to an inner side end in the longitudinal direction of the second connector 301 on the upper wall 353 and is formed so as to cover at least a portion, preferably essentially the entirety, of the inner wall surface of the protruding end part 322.

Note that the inner wall 351 functions as a contact point part and comes into contact with the contact part 258c of the shield plate 256 provided on the first connector 201. In addition, an upper end of the inner wall 351 has a bent upper wall connecting part that is connected to the upper wall 353, and a lower end of the inner wall 351 has a tail part 351b serving as a board connecting part that is bent such that a tip end faces to an inner side in the longitudinal direction of the second connector 301. The tail part 351b is parallel to the surface of the second board and is a portion connected by soldering or the like to the connection pad on the surface. The connection pad is typically connected to a ground line. Furthermore, a space with a circumference surrounded by the outer wall 352 corresponding to the pair of long side parts 350a and the pair of inner walls 351 is a second recessed part 313 into which the first protruding part 213 of the first connector 201 is inserted and stowed.

A flange part 354 serving as a flat part is connected to the lower end of the outer wall 352 through the bent part bent at an angle of approximately 90 degrees. The bent part and the flange part 354 are connected to the lower end of the outer wall 352 in a continuous manner around the entire periphery.

The flange part 354 functions as a board connecting part, a lower surface of which is parallel to the surface of the second board and is a portion connected by soldering or the like to the connection pad on the surface. The connection pad is typically connected to a ground line. Furthermore, the outer wall 352, in addition to being a continuous wall over the entire circumference itself, is connected to a member where a lower end thereof is continuous as with the flange part 354, which is a member extending in a direction orthogonal to the outer wall 352. Therefore, the outer wall is relatively rigid and resistant to deformation. In the present Embodiment, an example is described where the flange part 354 is connected to the lower end of the outer wall 352 continuously over the entire circumference, but the flange part may be connected only to a portion if relatively high rigidity is not required.

In addition, the outer wall 352 corresponding to the long side part 350a, and the short side part 350b has the outwardly protruding engaging protruding part 352c. The engaging protruding part 352c, functioning as a contact point part, is a portion that engages and is in contact with the engaging recessed part 251c formed on the inner wall 251 of the first shield 250 provided on the first connector 201 when the first connector 201 and the second connector 301 are mated with each other, and extends linearly in the longitudinal or width direction of the second connector 301. As described above, the outer wall 352 can be made flat by omitting the engaging protruding part 352c.

Note that the second shield 350 is integrated with the second housing 311 by over-molding or insert molding. In other words, the second housing 311 is molded by filling a cavity of a mold, in which the second shield 350 is internally set in advance, with an insulating material such as synthetic resin or the like, and is integrally connected to the second shield 350 at the protruding end part 322.

The second shield 350, which is a conductive member, is a member integrally formed by punching, drawing, and the like processing of a conductive metal plate that is a curvilinear member extending in the mating direction of the second connector 301 so the surface can be said to be an extension surface. Furthermore, the second shield 350 includes an engaging protruding part 352c as a contact point part and a flange part 254, which is a board connecting part, connected to the lower end of the outer wall 352 with an engaging protruding part 352c formed thereon. Note that in a collective description, the area of the outer wall 352 from the engaging protruding part 352c to the lower end of the outer wall 352 is described as a main body part. Further, the second shield 350 has an inner wall 351 as a contact point part and a tail part 351b as a board connecting part. Note that when collectively described, the area from the location on the inner wall 351 in contact with the contact part 258c of the shield plate 256 of the first connector 201 to the lower end of the inner wall 351 is described as a main body part. Furthermore, with the present Embodiment, the plating layer 92 including the first, second and third layers 92a, 92b, and 92c are formed on the extension surface of the second shield 350, which is a conductive member.

The second terminal 361 is a member integrally formed by punching, bending, or the like process on a conductive metal plate, and has: a retained part; a tail part serving as a board connecting part connected to a first end of the retained part; a lower connecting part connected to a second end of the retained part and extending in the vertical direction (Z-axis direction); and an upper connecting part connected to an upper end of the lower connecting part. Note that the surface of the lower connecting part is a contact part 365a, which functions as a contact point part, and comes into contact with the first terminal 261 provided on the first connector 201.

Furthermore, the second terminal 361 may be integrated with the second housing 311 by over-molding or insert molding. That is, the second housing 311 is molded by filling a cavity of a mold in which the second terminal 361 is set in advance with an insulating material such as a synthetic resin.

In addition, the tail is connected to the connection pad coupled to the conductive trace of the second board by soldering or the like. Note that the conductive trace may be a power line that supplies power, but is typically a signal line. In addition, the signal line is described assuming that the signal line does not transmit a high-frequency signal, but rather transmits a signal of normal frequency (for example, frequency less than 10 [GHz]), which is lower in frequency than high-frequency signals.

The second high-frequency terminal 371 is a member integrally formed by punching, bending, and the like processing of a conductive metal plate that is an elongated curvilinear member extending in the mating direction of the second connector 301 so the surface can be said to be an extension surface. In addition, the second high-frequency terminal 371 includes a retained part, a tail part connected to the lower end of the retained part as a board connecting part, and an upper connecting part connected to the upper end of the retained part. In addition, the upper connecting part is bent in an approximate S-shape when viewed from the longitudinal direction of the second connector 301, and a portion bent so as to bulge out toward the center in the width direction of the second connector 301 is a contact part 375a. The contact part 375a functions as a contact point part and is the portion that comes into contact with a first high-frequency terminal 271 provided on the first connector 201.

Note that the second high-frequency terminal 371 is not necessarily attached to the second housing 311 by press fitting but may be integrated with the second housing 311 by over-molding or insert molding. Herein, for convenience of description, a case in which the retained part is pressed into and retained by the second high-frequency terminal stowing groove of the second high-frequency terminal supporting part 316 will be described.

In addition, the tail is connected to the connection pad coupled to the conductive trace of the second board by soldering or the like. Note that the aforementioned conductive traces are signal lines, which are typically described as transmitting high-frequency signals of high-frequency (for example, frequency of 10 [GHz] or higher), such as RF signals.

The second high-frequency terminal 371 is press-fit through a mounting surface 301b that is a lower surface (Z-axis positive direction surface) of the second connector 301 into the second high-frequency terminal stowing groove of the second high-frequency terminal supporting part 316, and secured in the second housing 311. In this state, in other words, in a state in which the second high-frequency terminals 371 are installed in the second housing 311, the contacting parts 375a of the pair of second high-frequency terminals 371 face mutually opposite directions.

Note that in the example depicted in the drawings, the second high-frequency terminal 371 is formed to have the same dimensions and shape as the first high-frequency terminal 271. Therefore, the first high-frequency terminal 271 can be used as the second high-frequency terminal 371. Note that the tail part and contact part 275a of the first high-frequency terminal 271 or the tail part and contact part 375a of the second high-frequency terminal 371 may include an exposed surface exposed outside the first housing 211 or second housing 311, where these exposed surfaces may be formed mutually contiguous as a single exposed surface. In addition, each of the tail parts and contact parts may be formed on the extension surface of each of the high-frequency terminals and similar to Embodiment 1, the plating layer 92 may be formed on this extension surface.

Furthermore, the second connector 301 is placed on the surface of the second board with a second solder sheet (not shown) serving as a solder sheet applied to the mounting surface 301b side and is fixed and mounted on the surface of the second board by heating and melting the second solder sheet using a heating furnace or the like. Note that the means for connecting the second shield 350, second terminal 361, second high-frequency terminal 371, and the like to the connection pad or the like of the second board does not necessarily have to be application of a solder sheet, and may be application of solder paste, transfer of cream solder, dipping, jet soldering, or the like; however, for convenience of description, the case of using a solder sheet will be described.

The solder sheet contains: a pair of elongated strip shaped long side portions extending linearly and continuously in the longitudinal direction of the second connector 301; a pair of elongated strip shaped short side portions extending linearly and continuously in the width direction of the second connector 301; and a plurality of rectangular short length portions in which a long side extends in the width direction of the second connector 301 and a short side extends in the longitudinal direction of the second connector 301. Furthermore, a pair of long side portions are provided on a lower surface of the flange part 354 corresponding to the long side parts 350a of the second shield 350, a pair of short side portions are provided on the lower surface of the flange part 354 corresponding to the short side part 350b of the second shield 350, and a short side portion is provided on a lower surface of each tail part 351b of the inner wall 351.

When the second connector 301 is mounted on the surface of the second board by heating and melting a solder sheet applied in this manner, the flange part 354, which is connected continuously around the entire periphery, is connected without a gap to connection pads on the surface of the second board at the bottom of the outer wall 352, which is connected continuously around the entire periphery, of the second shield 350 that is a conductive member. Therefore, the strength of the second shield 350 connected to the connection pads on the surface of the second board is high, and consequently, the strength of the entire second connector 301 with an outer circumference surrounded by the second shield 350 is high. Furthermore, an electromagnetic shielding effect exerted by the second shield 350, which is connected without a gap to the connection pads on the surface of the second board, is very high, and the second connector 301 with an outer circumference surrounded by the second shield 350 is very effectively electromagnetically shielded. In particular, the smoothness of the lower surface of the flange part 354 is high. Thus, the strength of the second shield 350 connected to the connection pads on the surface of the second board can be made extremely high. Moreover, since no gap is created between the connection pads on the surface of the second board, the electromagnetic shielding effect can also be made extremely high. Furthermore, the area of the flange part 354 is set broader than the area of the engaging protruding part 352c that is a contact point part, to fully ensure soldering connection.

In addition, each of the protruding end parts 322 at two ends of the second connector 301 in the longitudinal direction are covered by the outer wall 352 of the second shield 350 on the outer wall surface facing an outer side in the longitudinal direction and two sides in the width direction of the second connector 301, the upper surface facing the mating surface 301a of the second connector 301 is covered by the upper wall 353 of the second shield 350, and the inner wall surface facing an inner side in the longitudinal direction of the second connector 301 is covered by the inner wall 351 of the second shield 350. Therefore, an entire circumference is shielded, and the second high-frequency terminal 371 supported by the second high-frequency terminal supporting part 316 formed on the protruding end part 322 is very effectively electromagnetically shielded.

Thus, the second connector 301 can transmit a high-frequency signal even with a compact and low profile, because the strength and the electromagnetic shielding effect are high. For example, even if the dimensions in the longitudinal, width, and height directions of the second connector 301 are set to 2.9 [mm] or less, 1.9 [mm] or less, and 0.6 [mm] or less, the second high-frequency terminal 371 can transmit a high-frequency signal of approximately 60 [GHz].

Next, the operation of mating the first connector 201 and the second connector 301 configured as described above will be described.

In order to mate the first connector 201 and the second connector 301, first, an operator places a mating surface 201a (Z-axis positive direction surface) of the first connector 201 and a mating surface 301a (Z-axis, negative direction surface) of the second connector 301 so as to face each other, as depicted in FIG. 7, and when the position of the first protruding part 213 of the first connector 201 matches the position of the second recessed part 313 of the second connector 301 and the position of the protruding end part 322 of the second connector 301 matches the position of the mating recessed part 212b corresponding to the first connector 1 [sic], positioning of the first connector 201 and the second connector 301 is complete.

In this state, when the first connector 201 and/or the second connector 301 are moved in a direction approaching a counterpart side, in other words, in a mating direction, the second shield 350 of the second connector 301 is inserted into the stowing part 250d of the first shield 250 of the first connector 201, the first protruding part 213 of the first connector 201 is inserted into the second recessed part 313 of the second connector 301, and the protruding end part 322 of the second connector 301 is inserted into the mating recessed part 212b of the first connector 201. Thus, when the mating of the first connector 201 and the second connector 301 is completed, the first terminal 261 and the second terminal 361 conduct electricity, and the first high-frequency terminal 271 and the second high-frequency terminal 371 achieve an electrically conductive state.

Specifically, the second protrusion 312 of the second housing 311 is inserted into the inner recessed groove part 212a of the first housing 211, and as depicted in FIG. 10B, the contacting part 265a of the first terminal 261 protruding from the inside surface of the first protruding part 213 into the inner recessed groove part 212a contacts the contact part 365a of the second terminal 361 exposed on the outer surface of the second protruding part 312. As a result, the conductive traces coupled to the connection pads on the first board to which the tail parts of the first terminals 261 are connected become conductive with the conductive traces coupled to the connection pads on the second board to which the tail parts of the second terminals 361 are connected.

Furthermore, the first high-frequency terminal supporting part 216 positioned in the mating recessed part 212b is inserted into the first high-frequency terminal stowing recessed part 316c of the protruding end part 322, and the contacting part 275a of the first high-frequency terminal 271 and the contacting part 375a of the second high-frequency terminal 371 contact each other as depicted in FIG. 10C. As a result, the conductive traces coupled to the connection pads on the first board to which the tail parts of the first high-frequency terminals 271 are connected become conductive with the conductive traces coupled to the connection pads on the second board to which the tail parts of the second high-frequency terminals 371 are connected.

Furthermore, when the second shield 350 of the second connector 301 is inserted into the stowing part 250d of the first shield 250 of the first connector 201, as depicted in FIGS. 10A and 10B, the engaging protruding part 352c formed on the outer wall 352 of the second shield 350 engages and comes into contact with the engaging recessed part 251c formed on the inner wall 251 of the first shield 250. Note that the linear part 251a of the inner wall 251, in which the engaging recessed part 251c is formed, is separated from another portion by the slit part 253a at two ends thereof and is relatively flexible; a state of engagement with the engaging protruding part 352c of the outer wall 352 of the second shield 350 can be reliably maintained. As a result, the first shield 250 and the second shield 350 become locked and release of the mating state between the first connector 201 and the second connector 301 is prevented. In addition, the state of the first shield 250 and the second shield 350 being in mutual contact can be maintained, enabling maintaining equipotential, improving electromagnetic shielding properties.

Furthermore, when the protruding end part 322 is inserted into the mating recess 212b, the contacting part 258c of the center part 258 of the shield plate 256 protrudes into the mating recessed part 212b and contacts the inner wall 351 of the second shield 350 covering the inner wall surface of the protruding end part 322, as depicted in FIG. 10A. In this manner, contact between the contact part 258c of the shield plate 256 and the inner wall 351 of the second shield 350 is maintained, enabling maintaining a stable equipotential and exhibiting a high shield effect.

In this manner, the first high-frequency terminal 271 and second high-frequency terminal 371, which are in contact with each other, have entire circumferences that are continuously surrounded by the inner wall 251, outer wall 252, and shield plate 256 of the first shield 250 and the inner wall 351 and outer wall 352 of the second shield 350, and moreover, are doubly surrounded, thereby being extremely effectively shielded. Therefore, the impedance of the transmission line of a signal from the tail part of the first high-frequency terminal 271 to the tail part of the second high-frequency terminal 371 is stabilized, and favorable SI characteristics can be achieved.

Note that the first shield 250 and second shield 350 do not necessarily need to contiguously enclose the periphery of the first connector 201 and the second connector 301 without any breaks and can either essentially contiguously enclose the periphery of the first connector 201 and second connector 301 or provide enclosure to an extent regarded as contiguous.

In addition, the extension surface that is the surface of the first shield 250, shield plate 256, and the second shield 350, which are conductive members, has the plating layer 92 formed thereon, the same as in Embodiment 1. Furthermore, the configuration of the plating layer 92 formed on the extension surface that is the surface of the first shield 250, shield plate 256, and second shield 350 is the same as that of Embodiment 1 and so a description is omitted.

In this manner, in the present Embodiment, the lower end of the shield plate 256 of the first connector 201 and the contact part 258c are positioned on the same straight line extending in the mating direction, or the engaging protruding part 352c of the second connector 301 and the flange part 354 as well as the inner wall 351 and the tail part 351b are positioned on the same straight line extending in the mating direction. Furthermore, the first shield 250 is at least one shield member that surrounds the periphery of the first connector 201 and the second shield 350 is a shield member that encloses the periphery of the second connector 301.

Note that configurations and operations of other components such as the first connector 201 and the second connector 301 of the present Embodiment are the same as those of Embodiment 1, and the description thereof is omitted.

Moreover, the disclosure herein describes features relating to suitable typical embodiments. Various other embodiments, modifications, and variations within the scope and spirit of the claims appended hereto will naturally be conceived of by those skilled in the art upon review of the disclosure herein.

The present disclosure can be applied to a connector and a connector pair.

1. A connector, comprising:
a housing; and
a conductive member,
wherein
the conductive member includes a main body part, a board connecting part positioned at a first end of the main body part, and a contact point part positioned at a second end of the main body part,
the main body part, board connecting part, and contact point part each include exposed surfaces exposed outside of the housing,
the main body part, board connecting part, and contact point part each include a metal base material and first to third layers formed on this metal base material, and
the first layer is a nickel or nickel alloy plating layer, the second layer is a platinum group metal or platinum group metal alloy plating layer, the third layer is a gold or gold alloy plating layer, the thickness of the second layer is 2 to 200 [nm], and the thickness of the third layer is 0.2 to 15 [nm].

2. The connector according to claim 1, wherein a thickness of the third layer is 0.5 to 8 [nm].

3. The connector according to claim 1, wherein the platinum group metal is palladium or palladium alloy.

4. The connector according to claim 1, wherein the first to third layers are formed on an extension surface of the conductive member.

5. The connector according to claim 1, wherein the respective exposed surfaces are formed contiguously to form a single exposed surface.

6. The connector according to claim 1, wherein the main body part, board connecting part, and contact point part are positioned on the same transverse plane extending in the mating direction.

7. The connector according to claim 1, wherein the board connecting part and contact point part are positioned on the same straight line extending in the mating direction.

8. The connector according to claim 1, wherein the conductive member is a plate shaped member and the board connecting part and contact point part are formed on an extension surface of the plate shaped member.

9. The connector according to claim 1, wherein the board connecting part area is broader than the contact point part area.

10. The connector according to claim 1, wherein the conductive member is a shield member surrounding the periphery of the connector.

11. The connector according to claim 1, wherein the conductive member is a terminal for power or a terminal for signals.

12. The connector according to claim 1, wherein the conductive member is a reinforcement fitting.

13. A connector pair, comprising the connector according to claim 1 and a counterpart connector that mates with the connector.
